(19) United States
(12) Patent Application Publication
(10) Pub. No.: US 2026/0001694 A1
(43) Pub. Date: Jan. 1, 2026

(54) DEVICE FOR PACKAGING IN A BATCH OF AT LEAST TWO CONTAINERS

(71) Applicant: SIDEL PARTICIPATIONS, Octeville-sur-Mer (FR)

(72) Inventors: Nicolas CHOMEL, OCTEVILLE-SUR-MER (FR); Mikaël DERRIEN, OCTEVILLE-SUR-MER (FR); Marion BOULANGER, OCTEVILLE-SUR-MER (FR); Xavier MONNIER, OCTEVILLE-SUR-MER (FR)

(21) Appl. No.: 19/250,493

(22) Filed: Jun. 26, 2025

(30) Foreign Application Priority Data
Jun. 28, 2024 (FR) FR2407088

(51) Int. Cl. B65D 71/50; B31D 1/00; B65D 65/46

(52) U.S. Cl. CPC B65D 71/50; B31D 1/0056; B65D 65/466; B65D 2565/383

(57) ABSTRACT

Disclosed are various embodiments of a device for packaging in a batch of at least two containers and methods of making the same. The device can be a sheet made of semi-rigid or rigid material, provided with at least two orifices for receiving necks of said containers. The sheet can have a substantially rectangular shape and include parallel rows of cups which are substantially frusto-conical, hemispherical or frusto-pyramidal. An internal wall of each cup bears against a shoulder of a container and the top of each cup has an orifice to receive the container neck. The device can be formed from a slip having decomposable and/or biodegradable vegetable fiber materials and additives, and the slip is suctioned to form the mold.

### CROSS-REFERENCE TO RELATED APPLICATIONS

This application claims the benefit of French Application No. FR2407088, filed Jun. 28, 2024, the entire contents of which is hereby incorporated herein by reference.

### TECHNICAL FIELD

### Background

As provided herein, a container is a bottle or a flask, the container comprising a bottom, a body and a shoulder connecting said body to a neck. Such a container is designed to contain, non-exhaustively, a fluid, a liquid, powders or granules, in particular of the food or cosmetic type.

For the purpose of the handling thereof, such finished containers are often packaged in batches. Thus each batch comprises a plurality of containers which are grouped together, for example, according to a matrix arrangement, generally of overall parallelepipedal shape, often square or a rectangle, in columns and rows, and possibly staggered. By way of illustration, a standard batch groups together six containers in two rows and three columns.

Once the groups of containers are produced, it is necessary to carry out a so-called shrink-wrapping step which includes wrapping a generally heat-shrinkable film around each group of containers in order to facilitate the handling of the batch thus obtained.

This step of shrink-wrapping results in a significant expenditure of energy. Moreover, the use of a film made of plastic material is harmful to the environment, almost half of plastic waste found in the oceans being single-use plastic objects. Currently, many plastics are called “recyclable,” but this approach is generally insufficient and unsatisfactory. More specifically, the use of shrink plastic films has many negative impacts on the environment: resulting expenditure of energy, single use, low recycling rates, huge export of plastic waste to countries having recycling infrastructures, etc. Moreover, the composition of the film, which is only partially recyclable, complicates the process and the waste produced will not be recycled in the vast majority of cases.

Moreover, the use of a plastic film which is wrapped around the products makes it impossible to separate one of the containers from the batch without causing the complete or partial dismantling thereof.

Thus, there is an increasing need to find an alternative to the use of this material which generates enormous quantities of waste and which is costly in terms of energy expenditure, while guaranteeing its robustness and permitting its handling.

In this regard, a known alternative to the use of a shrink plastic film for the formation of a batch is holding the products together by means of strapping or a plastic strap which surrounds the containers. This solution is not satisfactory since, apart from the fact that it requires the use of plastic, it generally requires making use of further additional means for sealing the batch, such as for example adhesives, and in the case of the removal of a container or a breakage of the strap it results in a complete dismantling of the batch of containers.

In order to remedy these drawbacks, solutions for packaging using cardboard have already been conceived. This is the case, in particular, in the documents US 2008/0257763 and WO 2013/185898.

The document US 2008/0257763 describes a solution using a cardboard tray which supports the products in the region of the bottom thereof. More specifically, this document describes a system for packaging bottles having a neck part. The system comprises a tray having a base on which a plurality of bottles are placed in a series of rows. The system also comprises a bridge having a planar central part and a plurality of arcuate recesses extending in a periphery of the planar central part. Each recess is dimensioned to receive a part of the neck of one of the bottles. A means of connecting the bottles together is provided, wherein the connecting means creates a force oriented toward the interior against the bottles. The bridge opposes the force oriented toward the interior and thus holds the bottles in the vertical position on the base.

This solution does not require the use of additional means such as glue. However, in this configuration it is not possible to lift the batch, nor to transport it in a simple manner. It is also not possible to transport a sub-group of products of the batch in a simple manner.

In order to be able to lift the batch, a further solution described in the document WO 2013/185898 uses a rigid board, made of cardboard or plastic, enabling the containers to be held in the region of a narrowing of the container in the region of its body. More specifically, this document describes a support element made of card, for example corrugated cardboard, cardboard or plastic material having greater rigidity, which is designed for containers grouped together into a grouped packaging. Said support element comprises a principal support which has an area for receptacles which is horizontal in a position of use, with housings for receptacles (6) which are produced in the form of a U-shaped cutout comprising a rounded base and U-shaped arms having the function of support limbs, in addition to a handle area. An external support can be connected to the area for receptacles, the external support which is produced in the form of a strip element having a plurality of opposing housings corresponding to the number of housings for the receptacles and produced in a corresponding manner in the form of a U-shaped cutout with a rounded base and U-shaped arms having the function of opposing support limbs.

However, while this solution makes it possible to lift the batch, it is very limited since it can be applied only to certain shapes of containers. Moreover, the solidity of the batch is not guaranteed, in particular in the case of the packaging of large-format containers.

Thus all of these solutions are unsatisfactory. More specifically, either they are always produced in a plastic material or, if they are provided with a gripping means, they do not guarantee the integrity of the batch when it is handled.

One of the objects of the present disclosure is thus to remedy these drawbacks by providing a device for packaging in a batch of at least two containers of simple and inexpensive design, guaranteeing the integrity of the batch during the handling thereof and advantageously obtained in a recyclable material without plastic material.

### SUMMARY

Embodiments of the present disclosure provide

An embodiment of the present disclosure includes

An embodiment of the present disclosure also includes

An embodiment of the present disclosure also includes

These and other aspects, objects, features, and embodiments will become apparent to a person of ordinary skill in the art upon consideration of the following detailed description of illustrative embodiments exemplifying the best mode as presently perceived.

### BRIEF DESCRIPTION OF THE DRAWINGS

For a more complete understanding of the embodiments and the advantages thereof, reference is now made to the following description, in conjunction with the accompanying figures briefly described as follows:

FIG. 1 is a perspective view of a first embodiment of the device for packaging;

FIG. 2 is a perspective view of a second embodiment of the device for packaging;

FIG. 3 is a perspective view of the sheet of the second embodiment of the device for packaging according to the embodiment shown in FIG. 2;

FIG. 4 is a view from above of the sheet of the device for packaging according to the embodiment shown in FIGS. 2 and 3;

FIG. 5 is a front view of the sheet of the device for packaging according to the embodiment shown in FIGS. 2 and 3;

FIG. 6 is a side view of the sheet of the device for packaging according to the embodiment shown in FIGS. 2 and 3;

FIG. 7 is a schematic view of a first step of the method for manufacturing a device for packaging according to example embodiments;

FIG. 8 is a schematic view of a second step of the method for manufacturing the device for packaging according example embodiments;

FIG. 9 is a schematic view of a third step of the method for manufacturing the device for packaging according example embodiments; and

FIG. 10 is a schematic view of a fourth and last step of the method for manufacturing the device for packaging according to example embodiments.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The following examples are put forth so as to provide those of ordinary skill in the art with a complete disclosure and description of how to perform the methods and use the devices and methods disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

### General Discussion

In accordance with the purpose(s) of the present disclosure, as embodied and broadly described herein, embodiments of the present disclosure, in some aspects, relate to packaging containers in batches and relates more particularly to a device for packaging in a batch of at least two containers.

In general, embodiments of the present disclosure provide for a device for packaging in a batch of at least two containers, said containers being bottles with a bottom, a body and a shoulder connecting said body to a neck, or cylindrical cans for example, said device comprising at least one sheet made of semi-rigid or rigid material, provided with at least two orifices for receiving the necks of said containers, wherein said sheet consists of a rough structure based on cellulose and/or natural fibers obtained by forming said rough structure based on cellulose and/or natural fibers from an aqueous-based slip and at least one decomposable and/or biodegradable vegetable fiber material, into which a first mold comprising at least one impression of the sheet is immersed, said first mold being provided with a vacuum suction system such that the cellulose and/or the natural fibers in suspension in the slip is suctioned into the impression of the first mold when the first mold is removed from the slip, an additional vacuum suctioning being applied in order to reduce the water content of the cellulose and/or the natural fibers, thus forming a sheet, then said sheet positioned in the impression of the first mold being pressed between said first mold and a second mold comprising at least one counter-impression of said sheet in order to reduce the water content, and said sheet being heated so as to obtain a two-dimensional or three-dimensional fibrous sheet having a single-layer configuration.

Thus, apart from the fact of being sufficiently rigid to package the bottles, the material from which the sheet is obtained has the advantage of providing improved mechanical and chemical properties for the cellulose sheet which is advantageously recyclable.

Said cellulose consists of recycled or non-recycled cellulose fibers and the decomposable and/or biodegradable vegetable fiber material consists of wood pulp and/or sugar cane pulp and/or reed pulp and/or bamboo pulp and/or palm pulp, or the like.

Moreover, the fibers have a length of between 0.5 and 3 mm and preferably a length of between 1 and 1.5 mm.

Moreover, the sheet obtained has a density of between 0.2 g/cm³ and 2 g/cm³. Preferably, said sheet obtained has a grammage of between 2 g/m² and 30 g/m².

Advantageously, the slip from which the sheet is obtained comprises one or more additives capable of changing the mechanical, hydrophobic and/or oleophobic properties of the sheet.

Said slip preferably comprises one or more additives from starch compounds, rosin compounds, butanetetracarboxylic acid, gelatine compounds, an alkyl ketene dimer (AKD), an alkenyl succinic anhydride (ASA), wax compounds, silicon compounds, calcium compounds, fluorocarbons or a combination thereof.

Moreover, the sheet obtained advantageously has a resistance to peeling of between 0.2 N/mm² and 1 N/mm².

According to a first embodiment, said sheet is planar and has a substantially rectangular shape and comprises at least two parallel rows of orifices capable of receiving the necks of the containers.

Each orifice comprises tongues extending in a petaloid manner toward the interior of each orifice.

Said tongues are obtained by creating radial slots from the internal edge of the orifices which have a smaller diameter than the diameter of the necks of the containers.

Advantageously, the device for packaging according to the invention comprises frangible opening means for each orifice.

Said frangible opening means consist of two parallel precut lines extending radially from the edge of an orifice.

Said precut lines of the frangible opening means extend perpendicularly to the longitudinal edge of the sheet.

Moreover, the sheet comprises two so-called gripping holes in its central part between the rows of orifices.

According to a second embodiment, said sheet has a substantially rectangular shape and comprises at least two parallel rows of cups which are substantially frusto-conical or hemispherical or frusto-pyramidal, or the like, the internal wall thereof being capable of bearing against the shoulder of the containers and the tops thereof being respectively provided with an orifice capable of receiving the neck of a container.

Said cups are connected in pairs by so-called longitudinal and transverse support bars.

Said support bars have an inverted U-shaped cross section.

Moreover, each orifice comprises tongues extending in a petaloid manner toward the interior of each orifice.

Said tongues are obtained by creating radial slots from the internal edge of the orifices which have a smaller diameter than the diameter of the necks of the containers.

Advantageously, the device for packaging according to the invention comprises frangible opening means for each orifice.

Said frangible opening means comprise or consist of two parallel precut lines or lines of weakness (having a minimal thickness) created in the cups and extending radially from the edge of an orifice.

According to a variant, said frangible opening means consist of two parallel lines of weakness having a minimal thickness, said lines of weakness being created in the cups and extending radially from the edge of an orifice.

Said precut lines and/or said lines of weakness of the frangible opening means extend perpendicularly to the longitudinal edge of the sheet.

Preferably, the device for packaging according to the invention comprises two rows of three cups, said cups being connected in pairs by a central transverse support bar, two lateral transverse support bars and longitudinal support bars.

Moreover, said device comprises two so-called central walls extending between two pairs of transverse and longitudinal support bars on either side of the central transverse support bar.

Each central wall is inclined from top to bottom from the central transverse support bar toward a lateral transverse support bar, i.e. toward a transverse edge of the sheet.

Advantageously, each central wall comprises a so-called gripping hole.

Each gripping hole has a circular, oblong or ovoid shape.

A further subject of the invention relates to a method for manufacturing a device for packaging in a batch of at least two containers, said containers being bottles with a bottom, a body and a shoulder connecting said body to a neck, or cylindrical cans for example, said device comprising at least one sheet made of semi-rigid or rigid material, provided with at least two orifices for receiving the necks of said containers, the method comprising at least the following steps of:
a) preparing an aqueous-based slip, also called a pulp, by mixing water, cellulose and/or a decomposable and/or biodegradable vegetable fiber material;
b) introducing a first mold comprising at least one impression of the sheet (8) into the slip, said first mold being provided with a vacuum suction system such that the cellulose and/or the natural fibers in suspension in the slip is (are) suctioned into the impression of the first mold, thus forming an intermediate sheet;
c) pressing said intermediate sheet positioned in the impression of the first mold between said first mold and a second mold comprising at least one counter-impression of said sheet in order to reduce the water content;
d) heating said sheet to a temperature of between 120° C. and 240° C.

Said decomposable and/or biodegradable vegetable fiber material consists of wood pulp and/or sugar cane pulp and/or rosin pulp and/or bamboo pulp and/or palm pulp, or the like.

Advantageously, one or more additives capable of changing the mechanical, hydrophobic and/or oleophobic properties of the sheet is (are) introduced into the slip during the step a) of preparing said slip.

Said additive or additives are selected from starch compounds, rosin compounds, butanetetracarboxylic acid, gelatine compounds, an alkyl ketene dimer (AKD), an alkenyl succinic anhydride (ASA), wax compounds, silicon compounds, calcium compounds, fluorocarbons or a combination thereof.

Moreover, the cellulose consists of recycled or non-recycled cellulose fibers.

Preferably, said fibers have a length of between 0.5 and 3 mm and preferably a length of between 1 and 1.5 mm.

Preferably, when the first mold is removed from the slip, an additional vacuum suctioning is applied in order to reduce the water content of the cellulose and/or the natural fibers.

Moreover, the pressure applied between the molds 104 and 106 is between 0.5 MPa and 60 MPa.

According to a first variant, said sheet is heated between the first mold and the second mold to a temperature of between 120° C. and 240° C. before being removed, so as to obtain a two-dimensional or three-dimensional fibrous sheet having a single-layer configuration.

According to a second variant, the step of heating the sheets is carried out in a heat tunnel, the sheets being previously removed from the molds.

Turning now to the drawings, exemplary embodiments are described in detail.

### Examples

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

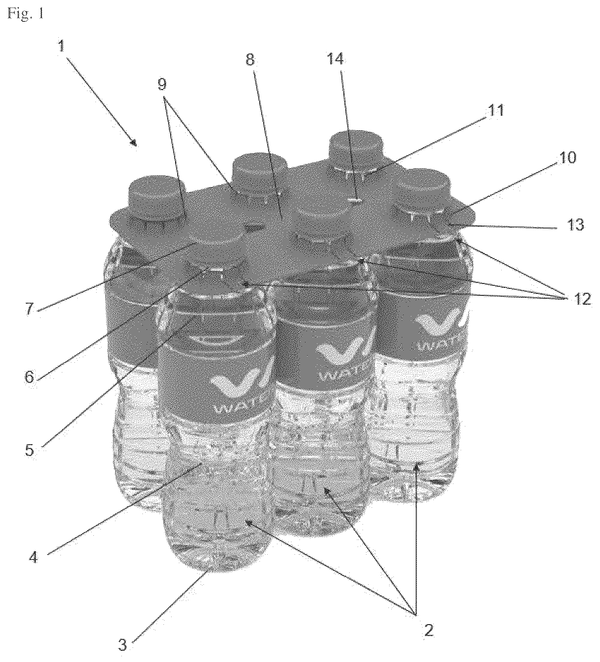

A device for packaging 1 in a batch of at least two containers 2 is described hereinafter with reference to FIG. 1, said containers 2 being bottles with a bottom 3, a body 4, which is substantially cylindrical, and a shoulder 5 connecting said body 4 to a neck 6, said neck receiving a cap 7. Said device for packaging 1 comprises at least one sheet 8 made of semi-rigid or rigid material which will be described in more detail below, provided with at least two orifices 9 for receiving the necks 6 of said containers 2.

In this particular exemplary embodiment, said sheet 8 is planar, it has a substantially rectangular shape and comprises at least two parallel rows of three orifices 9 capable of receiving the necks 6 of the containers 2 in order to obtain a batch of six bottles, the batches of bottles usually comprising six bottles.

Each orifice 9 receiving the necks 6 of the containers comprises tongues 10 extending in a petaloid manner toward the interior of each orifice 9. Said tongues 10 are obtained by creating radial slots 11 from the internal edge of the orifices 10 which have a smaller diameter than the diameter of the necks 6 of the containers 2. After introducing the necks 6 of the containers 2 into the orifices 9, the free ends of the tongues 10 are housed below the lower end of the caps, by extending between the neck 6 and the lower end of the cap, thus avoiding that the container 2 escapes from the orifice 9. In order to remove the container 2, it suffices to exert a pulling force downwardly and/or in rotation toward the outside by gripping the container 2 by its body 4 such that said tongues 10 are turned back or torn off.

Advantageously, in order to facilitate the removal of the containers 2 from the sheet 8, the device for packaging 1 according to the invention comprises frangible opening means 12 for each orifice 9. Said frangible opening means 12 consist of two parallel precut lines 13 extending radially from the edge of an orifice 9. Said precut lines 13 of the frangible opening means 12 extend perpendicularly to the longitudinal edge of the sheet 8.

According to a variant, not shown in the figures, said precut lines 13 of the frangible opening means 12 could be substituted by parallel lines of weakness which are characterized by a minimal thickness of the cups 15 in the region of these lines of weakness.

As can be envisioned by a person having ordinary skill in the art, the precut lines 13 of the frangible opening means 12 could be substituted by any other equivalent means well known to a person skilled in the art without departing from the scope of the invention.

Moreover, in order to facilitate the gripping of the device for packaging according to the invention, the sheet 8 comprises two so-called gripping holes 14 in its central part between the rows of orifices 9. Thus, it is possible to grip the device for packaging by introducing two fingers, such as the thumb and the index finger of one hand, into said gripping holes.

As can be envisioned by a person having ordinary skill in the art, said gripping holes 14 could be substituted by frangible flaps of substantially ovoid shape without departing from the scope of the invention.

In addition, the angles of the sheet 8 are rounded in order to avoid any injury during the handling of the batch of bottles.

According to a preferred embodiment, said sheet 8 consists of a rough structure based on cellulose and/or natural fibers obtained by forming said rough structure based on cellulose and/or natural fibers from an aqueous-based slip and at least one decomposable and/or biodegradable vegetable fiber material into which a first mold comprising at least one impression of the sheet is immersed, said first mold being provided with a vacuum suction system such that the cellulose and/or the natural fibers in suspension in the slip is (are) suctioned into the impression of the first mold when the first mold is removed from the slip, an additional vacuum suctioning being applied in order to reduce the water content of the cellulose and/or the natural fibers, thus forming a sheet 8, then said sheet 8 positioned in the impression of the first mold being pressed between said first mold and a second mold comprising at least one counter-impression of said sheet 8 in order to reduce the water content, and said sheet 8 being heated between the first mold and the second mold before being removed so as to obtain a two-dimensional or three-dimensional sheet 8 having a single-layer configuration.

Apart from being sufficiently rigid to package the bottles, the material from which the sheet 8 is obtained has the advantage of providing improved mechanical and chemical properties to the sheet 8 which is advantageously recyclable.

The cellulose consists of recycled or non-recycled cellulose fibers and the vegetable fiber and/or biodegradable material consists of wood pulp and/or sugar cane pulp and/or reed pulp and/or bamboo pulp and/or palm pulp, or the like.

Said fibers have a length of between 0.5 and 3 mm and preferably a length of between 1 and 1.5 mm.

Moreover, the sheet obtained has a density of between 0.2 g/cm³ and 2 g/cm³, preferably between 0.3 g/cm³ and 1 g/cm³, said sheet obtained having a grammage of between 2 g/m² and 30 g/m².

Advantageously, the slip from which the sheet 8 is obtained comprises one or more additives capable of changing the mechanical, hydrophobic and/or oleophobic properties of the sheet.

Said additive or additives are selected, for example, from starch compounds, rosin compounds, butanetetracarboxylic acid, gelatine compounds, an alkyl ketene dimer (AKD), an alkenyl succinic anhydride (ASA), wax compounds, silicon compounds, calcium compounds, fluorocarbons or a combination thereof.

Moreover, the sheet 8 obtained advantageously has a resistance to peeling of between 0.2 N/mm² and 1 N/mm². It will also be noted that the sheet 8 is held between the first mold comprising the impression of the sheet 8 and the second mold comprising the counter-impression of the sheet 8 by applying a pressure of between 0.5 MPa and 60 MPa and by applying a temperature of between 120° C. and 240° C.

The method of manufacturing the device for packaging according to the invention will now be explained with reference to FIGS. 7 to 10.

In a first step, with reference to FIG. 7, the aqueous-based slip, also called the pulp, is prepared in a pulper 100 consisting of a tank 101 and rotating blades 102 and/or toothed discs, by introducing into said pulper 100 water, cellulose and/or a decomposable and/or biodegradable vegetable fiber material, such as wood pulp and/or sugar cane pulp and/or reed pulp and/or bamboo pulp and/or palm pulp, or the like. In addition, in this step, one or more additives capable of changing the mechanical, hydrophobic and/or oleophobic properties of the sheet can be introduced into the pulper 100, said additive or additives being selected, for example, from starch compounds, rosin compounds, butanetetracarboxylic acid, gelatine compounds, an alkyl ketene dimer (AKD), an alkenyl succinic anhydride (ASA), wax compounds, silicon compounds, calcium compounds, fluorocarbons or a combination thereof. The cellulose consists of recycled or non-recycled cellulose fibers and said fibers have a length of between 0.5 and 3 mm and preferably a length of between 1 and 1.5 mm. The combination thereof being mixed until a slip or homogenous pulp is obtained, and which has a desired viscosity.

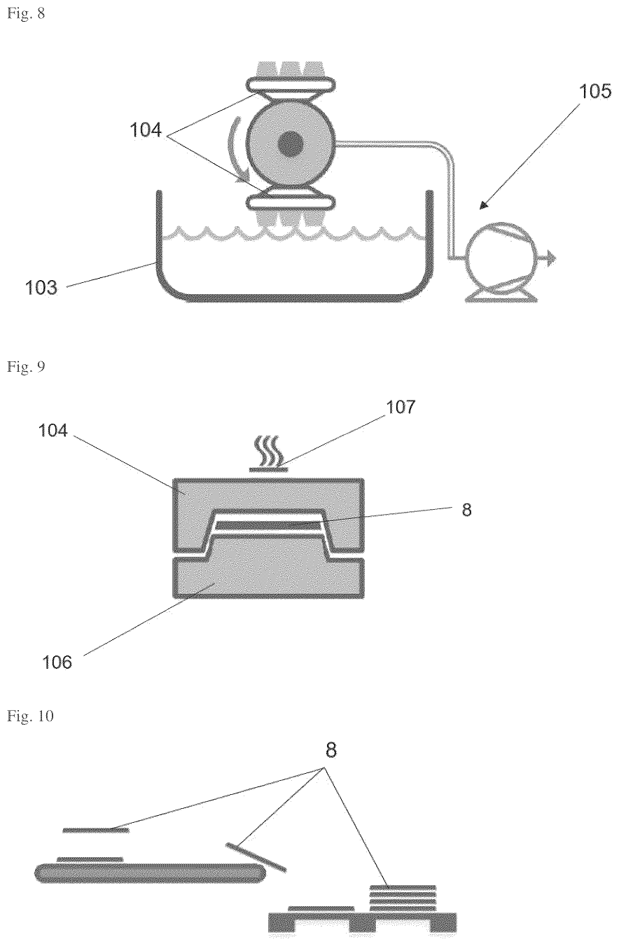

In a second step, with reference to FIG. 8, once the slip obtained in the preceding step has been transferred into a so-called molding tank 103, a first mold 104 comprising at least one impression of the sheet 8 is immersed into the slip of the molding tank 103, said first mold 104 being provided with a vacuum suction system 105 such that the cellulose and/or the natural fibers in suspension in the slip is (are) suctioned into the impression of the first mold 104. When the first mold 104 is removed from the slip, an additional vacuum suctioning is applied in order to reduce the water content of the cellulose and/or the natural fibers, thus forming an intermediate sheet 8.

Then in a third step, with reference to FIG. 9, said intermediate sheet 8 which is positioned in the impression of the first mold 104 is pressed between said first mold 104 and a second mold 106 comprising at least one counter-impression of said sheet 8 in order to reduce the water content, the pressure applied between the molds 104 and 106 being between 0.5 MPa and 60 MPa. Moreover, said sheet 8 is heated between the first mold 104 and the second mold 105 to a temperature of between 120° C. and 240° C. before being removed, so as to obtain a two-dimensional or three-dimensional fibrous sheet 8 having a single-layer configuration.

It will be observed that, in this variant, said sheet 8 is heated by means of a heating system 107 of the first mold 104 and/or the second mold 106; however, it is obvious that the sheet 8 could be transferred into other molds specifically dedicated to heating without departing from the scope of the invention.

Moreover in a variant, not shown in the figures, the step of heating the sheets 8 can be carried out in a heat tunnel, the sheets 8 being previously removed from the molds 104 and 106.

In a final step, with reference to FIG. 10, after heating the sheets 8 are removed from the molds 104 and 106 and are finally stacked and palletized, ready for packaging in a batch of a plurality of containers as bottles made of PET, for example.

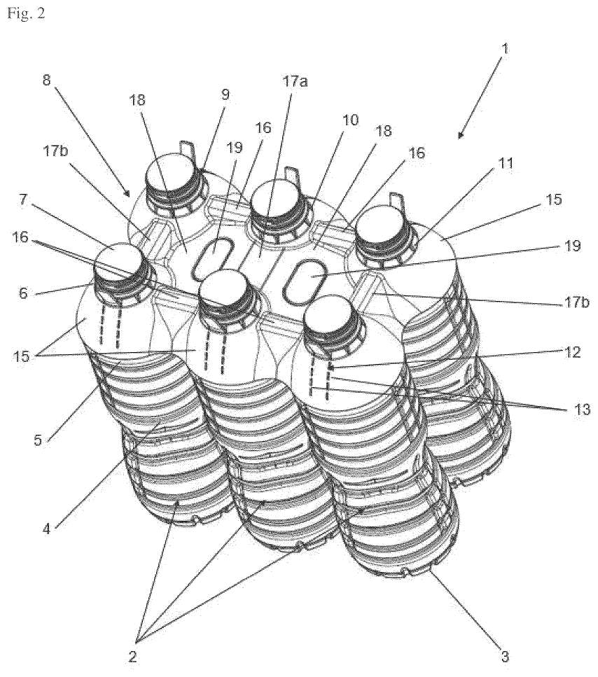

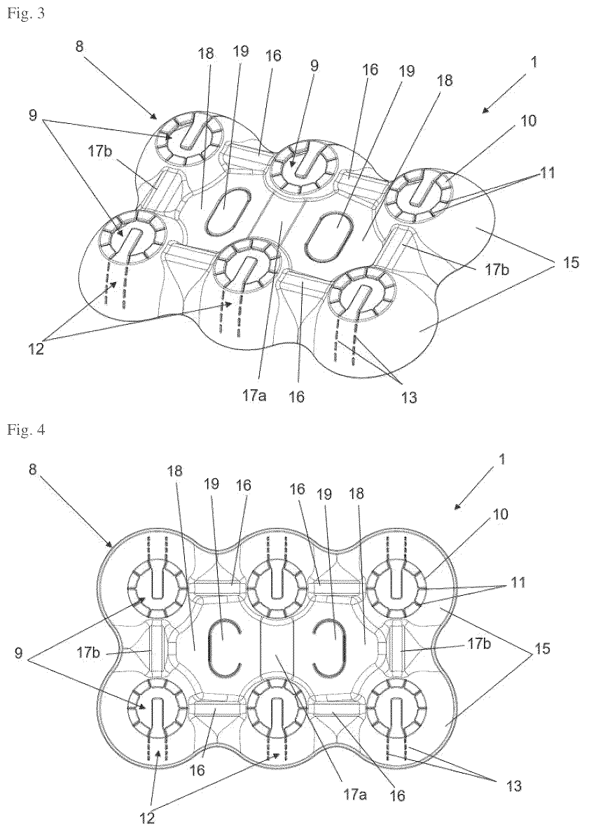

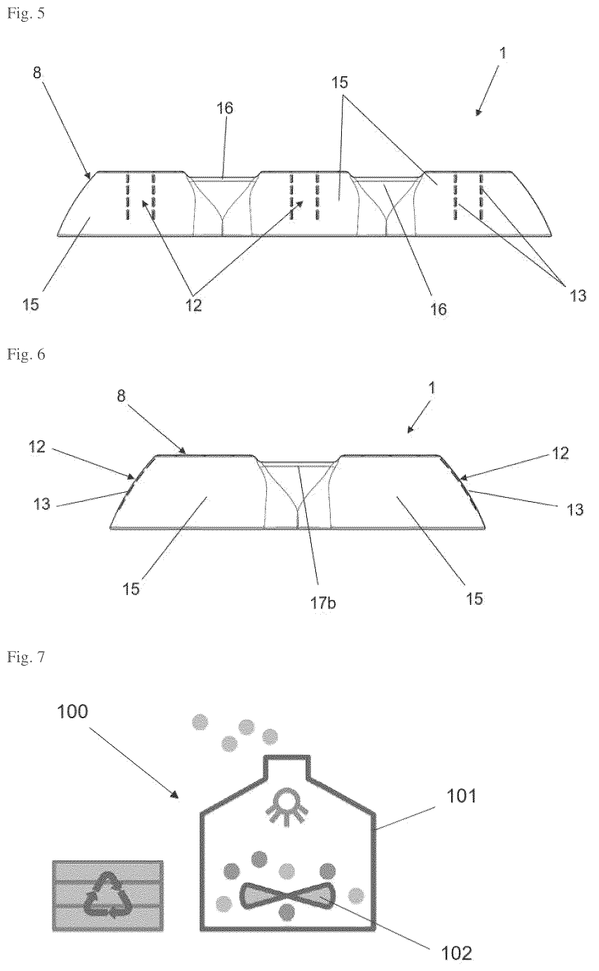

According to a second embodiment of the device for packaging according to the invention, with reference to FIGS. 2 to 6, said device for packaging 1 in a batch of at least two containers 2 according to the invention, said containers 2 being bottles with a bottom 3, a body 4, which is substantially cylindrical, and a shoulder 5 connecting said body 4 to a neck 6, said neck receiving a cap 7, comprises in the same manner as before at least one sheet 8 made of semi-rigid or rigid material, said material being identical to that described above, provided with at least two orifices 9 for receiving the necks 6 of said containers 2.

In this particular exemplary embodiment, said sheet 8 has a substantially rectangular shape and comprises at least two parallel rows of cups 15 which are substantially frusto-conical or hemispherical or frusto-pyramidal, or the like, the internal wall thereof being capable of bearing against the shoulder 5 of the containers 2 and the tops thereof being respectively provided with an orifice 9 capable of receiving the neck 6 of a container 2. It will be noted that the tops of said cups 15 extend in the same plane, which is considered horizontal to the extent that the containers 2 are packaged in a batch usually in a vertical position. It goes without saying that the shoulders 5 of the containers bearing against the internal wall of the cups 15 makes it possible to ensure an improved hold of the containers 2 on the sheet 8 by avoiding the rotation of the neck 6 of the containers 2 in the orifices 9 and holding the containers against one another by avoiding their separation during the handling, transport etc. of the batch.

As can be appreciated by a person having ordinary skill in the art, said cups 15 have a shape which conforms to that of the shoulders of the containers without departing from the scope of the invention. More specifically, said containers 2, namely bottles in this case, can comprise shoulders of substantially hemispherical, frusto-conical or frusto-pyramidal shape, in particular the body of the bottles being able to have a cross section which is circular, ovoid, square, etc.

Said cups 15 are connected in pairs by so-called longitudinal 16 and transverse 17 support bars. Said support bars 16, 17 extend in the same horizontal plane, extending below the horizontal plane of the orifices 9 and having an inverted U-shaped or V-shaped cross section, the concavity of the support bars being oriented downwardly. These support bars 16, 17 make it possible to stiffen the sheet 8 and avoid a dismantling of the batch.

As can be envisioned by a person having ordinary skill in the art, said support bars 16, 17 could have any shape and/or be solid without otherwise departing from the scope of the invention.

Each orifice 9 receiving the necks 6 of the containers comprises tongues 10 extending in a petaloid manner toward the interior of each orifice 9. Said tongues 10 are obtained by creating radial slots 11 from the internal edge of the orifices 10 which have a smaller diameter than the diameter of the necks 6 of the containers 2. After introducing the necks 6 of the containers 2 into the orifices 9, the free ends of the tongues 10 are housed below the lower end of the caps, extending between the neck 6 and the lower end of the cap, thus avoiding that the container 2 escapes from the orifice 9. In order to remove the container 2, it suffices to exert a pulling force downwardly by gripping the container 2 by its body 4 such that said tongues 10 are turned back or torn off.

Advantageously, in order to facilitate the removal of the containers 2 from the sheet 8, the device for packaging 1 according to the invention comprises frangible opening means 12 for each orifice 9. Said frangible opening means 12 consist of two parallel precut lines 13 extending radially from the edge of an orifice 9. Said precut lines 13 of the frangible opening means 12 extend perpendicularly to the longitudinal edge of the sheet 8.

In the same manner as above, and according to a variant not shown in the figures, said precut lines 13 of the frangible opening means 12 could be substituted by parallel lines of weakness which are characterized by a minimal thickness of the cups 15 in the region of these lines of weakness.

As can be envisioned by a person having ordinary skill in the art, the precut lines 13 of the frangible opening means 12 could be substituted by any other equivalent means well known to a person skilled in the art without departing from the scope of the invention.

Moreover, in this particular exemplary embodiment, the device for packaging 1 according to the invention comprises two rows of three cups 15, said cups 15 being connected in pairs by a central transverse support bar 17a, two lateral transverse support bars 17b and longitudinal support bars 16. Said device also comprises two so-called central walls 18 extending between two pairs of transverse 17 and longitudinal 16 support bars on either side of the central transverse support bar 17a. Each central wall 18 is preferably planar and inclined from top to bottom from the central transverse support bar 17a toward a lateral transverse support bar 17b, i.e. toward a transverse edge of the sheet 8. Each central wall 18 forms an angle of between 5 and 30° with the horizontal plane containing the orifices 9. It will be noted that said central walls 18 could advantageously receive a label, not shown in the figures.

Moreover, in order to facilitate the gripping of the device for packaging according to the invention, the sheet 8 comprises in its central part, between the rows of orifices 9, two frangible flaps 19 capable of forming gripping holes. Thus it is possible to grip the device for packaging by introducing two fingers, such as the thumb and the index finger of one hand, into said gripping holes after having lowered said frangible flaps 19. Said frangible flaps 19 have a substantially oblong shape; however said frangible flaps 19 could have any shape, such as a rectangular, circular or ovoid shape, for example, without departing from the scope of the invention.

As can be envisioned by a person having ordinary skill in the art, said frangible flaps 19 could be substituted by gripping holes without departing from the scope of the invention.

Finally, the examples given above are only particular illustrations and are in no way limiting relative to the fields of application of the invention.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, “about 0” can refer to 0, 0.001, 0.01, or 0.1. In an embodiment, the term “about” can include traditional rounding according to significant figures of the numerical value. In addition, the phrase “about ‘x’ to ‘y’” includes “about ‘x’ to about ‘y’”.

Therefore, at least the following is claimed:

1. A device for packaging in a batch of at least two containers, comprising:
a sheet made of semi-rigid or rigid material, provided with at least two orifices for receiving necks of said containers, wherein said sheet comprises a rough structure, the rough structure comprising one or both of cellulose and natural fibers, wherein the rough structure is molded from an aqueous-based slip and at least one decomposable and/or biodegradable vegetable fiber material, wherein the sheet is pressed between a first mold and a second mold to reduce water content and heated to obtain a two-dimensional or three-dimensional fibrous sheet having a single-layer configuration.

2. The device of claim 1, wherein the cellulose comprises recycled or non-recycled cellulose fibers.

3. The device of claim 2, wherein the decomposable and/or biodegradable vegetable fiber material comprises at least one of wood pulp, sugar cane pulp, reed pulp, bamboo pulp, and palm pulp.

4. The device of claim 3, wherein the fibers have a length of between 0.5 and 3 mm.

5. The device of claim 4, wherein the sheet obtained has a density of between 0.2 g/cm³ and 2 g/cm³.

6. The device of claim 5, wherein the sheet obtained has a grammage of between 2 g/m² and 30 g/m².

7. The device of claim 6, wherein the aqueous-based slip comprises one or more additives selected from the group consisting of starch compounds, rosin compounds, butanetetracarboxylic acid, gelatine compounds, an alkyl ketene dimer (AKD), an alkenyl succinic anhydride (ASA), wax compounds, silicon compounds, calcium compounds, fluorocarbons and combinations thereof, and wherein the additives change the mechanical, hydrophobic and/or oleophobic properties of the sheet when compared with a slip not comprising the additive.

8. A device for packaging in a batch of at least two containers, comprising:
a sheet made of semi-rigid or rigid material, provided with at least two orifices for receiving necks of said containers, wherein said sheet has a substantially rectangular shape and comprises at least two parallel rows of cups which are substantially frusto-conical, hemispherical or frusto-pyramidal, an internal wall of each cup being capable of bearing against a shoulder of a container and a top of each cup being provided with an orifice configured to receive a neck of a container.

9. The device of claim 8, wherein the cups are connected in pairs by longitudinal and transverse support bars.

10. The device of claim 9, wherein the support bars have an inverted U-shaped or V-shaped cross section.

11. The device of claim 10, wherein each orifice comprises tongues extending in a petaloid manner toward an internal edge of each orifice.

12. The device of claim 11, wherein the tongues are formed from radial slots from the internal edge of the orifices, the orifices having a smaller diameter than a diameter of the necks of the containers.

13. The device of claim 12, further comprising frangible opening means for each orifice.

14. The device of claim 13, wherein the frangible opening means comprise two parallel precut extending radially from the internal edge of each orifice into the cups.

15. The device of claim 14, wherein the sheet comprises two central walls extending between two pairs of transverse and longitudinal support bars on either side of a central transverse support bar, each central wall being inclined from top to bottom from the central transverse support bar toward a lateral transverse support bar.

16. A method for manufacturing a device for packaging in a batch of at least two containers, comprising:
preparing an aqueous-based slip by mixing water, cellulose and/or a decomposable and/or biodegradable vegetable fiber material;
introducing a first mold comprising at least one impression of a sheet into the slip, said first mold being provided with a vacuum suction system such that the cellulose and/or the natural fibers in suspension in the slip is suctioned into the impression of the first mold;
pressing an intermediate sheet positioned in the impression of the first mold between said first mold and a second mold comprising at least one counter-impression of said sheet to reduce water content; and
heating said sheet to a temperature of between 120° C. and 240° C.

17. The method of claim 16, wherein the decomposable and/or biodegradable vegetable fiber material comprises at least one of wood pulp, sugar cane pulp, reed pulp, bamboo pulp, and palm pulp.

18. The method of claim 17, introducing into the slip, during the step of preparing the slip, one or more additives capable of changing the mechanical, hydrophobic and/or oleophobic properties of the sheet.

19. The method of claim 18, wherein said additive or additives are selected from starch compounds, rosin compounds, butanetetracarboxylic acid, gelatine compounds, an alkyl ketene dimer (AKD), an alkenyl succinic anhydride (ASA), wax compounds, silicon compounds, calcium compounds, fluorocarbons or a combination thereof.

20. The method of claim 19, wherein when the first mold is removed from the slip, an additional vacuum suctioning is applied to reduce the water content of the cellulose and/or the natural fibers.

21. The method of claim 20, wherein the pressure applied between the first mold and the second mold is between 0.5 MPa and 60 MPa.

22. The method of claim 21, wherein the sheet is heated between the first mold and the second mold to a temperature of between 120° C. and 240° C. before being removed.

23. The method of claim 22, wherein the sheet obtained has a resistance to peeling of between 0.2 N/mm² and 1 N/mm².
